(19) United States
(12) Patent Application Publication
(10) Pub. No.: US 2022/0194787 A1
(43) Pub. Date: Jun. 23, 2022

(54) CHEMICAL LOOPING PROCESS FOR THE PRODUCTION OF HYDROGEN

(71) Applicant: Commonwealth Scientific and Industrial Research Organization, Acton, Australian Capital Territory (AU)

(72) Inventors: Kok-Seng LIM, Acton, Australian Capital Territory (AU); Trevor Deon HADLEY, Acton, Australian Capital Territory (AU); Doki YAMAGUCHI, Acton, Australian Capital Territory (AU); Liangguang TANG, Acton, Australian Capital Territory (AU); José ORELLANA, Acton, Australian Capital Territory (AU)

(21) Appl. No.: 17/604,537

(22) PCT Filed: Apr. 15, 2020
(86) PCT No.: PCT/AU2020/050369

§ 371 Date: Oct. 18, 2021

(30) Foreign Application Priority Data
Apr. 18, 2019 (AU) 2019901354

(51) Int. Cl. C01B 3/06; C01B 32/50; B01J 8/26; B01J 19/24

(52) U.S. Cl. CPC C01B 3/061; C01B 32/50; B01J 8/26; B01J 19/2465; C01B 2203/148; C01B 2203/0255; C01B 2203/0811; C01B 2203/1241; B01J 2208/00938; B01J 19/245

(57) ABSTRACT

A chemical looping process for the production of hydrogen and the co-production of carbon dioxide comprising: a first redox loop that comprises: feeding of a first solid oxygen carrier to a first reaction zone (R1) in which a first carbonaceous fuel is also fed, which reacts with the first solid oxygen carrier fed at its maximum oxidising state (fully-oxidised form), leading to the formation of the combustion products carbon dioxide and water and the solid oxygen carrier at a lower oxidising state (reduced form); and feeding of the first solid oxygen carrier in reduced form to a second reaction zone (R2) into which air is also fed, obtaining, from the oxidation of the first solid oxygen carrier, heat and the solid oxygen carrier in fully-oxidised form to be recycled to the first reaction zone (R1); and a second redox loop that comprises: feeding of a second solid oxygen carrier to a third reaction zone (R3) in which a second carbonaceous fuel is also fed, which reacts with the second solid oxygen carrier fed at its an intermediate oxidising state (oxidised form), leading to the formation of the combustion products carbon dioxide and water and the solid oxygen carrier at a lower oxidising state (reduced form); and feeding of the second solid oxygen carrier in reduced form to a fourth reaction zone (R4) into which steam is also fed, which reacts with the reduced form of the solid oxygen carrier, producing hydrogen and the solid oxygen carrier at an intermediate oxidising state (oxidised form) to be recycled to the third reaction zone (R3) and/or the first reaction zone (R1), wherein the first reaction zone (R1) and the third reaction zone (R3) are interconnected allowing transfer of at least a portion of the first solid oxygen carrier from the first reaction zone (R1) to the third reaction zone (R3).

### PRIORITY CROSS-REFERENCE

The present application claims priority from Australian provisional patent application No. 2019901354 filed on 18 Apr. 2019, the contents of which should be considered to be incorporated into this specification by this reference.

### TECHNICAL FIELD

The present invention generally relates to a chemical looping process for the conversion of carbonaceous fuel using a solid oxygen carrier (typically a multivalence metal oxide) to produce hydrogen (H₂) and to co-produce carbon dioxide (CO₂) in separate streams.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Hydrogen is an attractive energy carrier due to its potentially high energy efficiency and low generation of pollutants, which can be used for transportation and stationary power generation. However, hydrogen is not readily available in sufficient quantities and the production cost of current hydrogen generation processes is high. Steam methane reforming (SMR) process is a widely used commercial technology for H₂ production. However, this process requires a robust catalyst and purification processes for separation of carbon dioxide and hydrogen for production of a high purity hydrogen. In comparison, hydrogen production using chemical looping technology is a promising alternative because it can produce high purity hydrogen with an inherent separation of carbon dioxide. Chemical looping technology can also provide a simplified process, as it potentially eliminates the post purification/separation processes for production of high purity hydrogen, which are mandatory for the SMR process.

In chemical looping combustion (CLC), oxygen carrier particles replace gaseous oxygen (in air) as the direct oxygen supply to support fuel combustion. This approach avoids dilution of combustion off-gas by nitrogen (N₂) from air which generally complicates downstream carbon dioxide separation, capture and sequestration. A basic CLC process is often formed using a two reactor system comprising a Fuel Reactor (FR) and an Air Reactor (AR) coupled together to form a redox loop with oxygen circulated between them using a solid oxygen carrier (usually metal oxide particles). The AR and FR are operated under oxidising and reducing conditions respectively using different reactor configurations, for example fluidised bed technology with inter-connected beds.

In the FR, the solid oxygen carrier particles are reduced by the fuels, and the fuels are oxidised to CO₂ and H₂O through reaction 1. In the AR, the solid oxygen carrier particles are oxidised with gaseous O₂ back to their initial state through reaction 2. The combustion products of CO₂ and H₂O are not diluted with nitrogen because the fuel and air are separately introduced in CLC. This means that by condensing the H₂O, it is possible to obtain almost pure CO₂ without expending any extra energy needed for separation.

(2n+m)MₓO_{y}+CₙH₂ₘ=(2n+m)MₓO_{y-1}+mH₂O+nCO₂ (1)

MₓO_{y-1}+1/2O₂=MₓO_{y} (2)

In these processes, the reaction between the feed gaseous oxygen and hydrocarbon-based fuel is indirect as the oxygen exchange takes place through a solid oxygen carrier capable of providing one or more intermediate redox pairs (MₓO_{y}/MₓO_{y-1}; MₓO_{y-1}/MₓO_{y}) between the reducing potential of the CₙH₂ₘ/CO₂ pair and the oxidising potential of the O₂/H₂O pair. In practice, the solid oxygen carrier acts as oxygen donor to the hydrocarbon-based fuel (reducing agent) and oxygen receiver from the oxygen (oxidising agent).

In a typical CLC configuration used for power generation, the AR heat duty is used to raise steam for electricity generation via a steam turbine. If the system is operated at elevated pressures, the AR off-gas can be expanded through a gas turbine to generate additional electricity.

Hydrogen can be produced using a chemical looping (CL) system by replacing the AR with a steam reactor (SR). Again, the reaction between steam and hydrocarbon-based fuel (for example natural gas (CH₄)) is indirect as the oxygen exchange takes place through a solid oxygen carrier capable of providing one or more intermediate redox pairs (MₓO_{y}/MₓO_{y-1}; MₓO_{y-1}/MₓO_{y} as above) between the reducing potential of the CH₄/CO₂ pair and the oxidising potential of a H₂O/H₂ pair. An example of this type of hydrogen production system is a steam-iron process such as the process taught in U.S. Pat. No. 3,442,620. However, these processes suffer the disadvantage of having a low chemical process yield (in the order of 65%), and require significant energy input, as the overall process is endothermic (the reaction is CH₄+2H₂O→CO₂+4H₂).

The thermal balance of the overall CL hydrogen generation process can be improved by using a SR in series with an AR in the redox loop, for example as shown in FIG. 1. In such chemical looping hydrogen generation processes the FR is used to partially reduce the oxygen carrier and the reduced oxygen carrier is oxidised with steam in a steam reactor (SR), which recovers lattice oxygen and simultaneously produces hydrogen. The AR is then used to fully recover the lattice oxygen as can be expressed as follows:

Methane Reduction: MₓO_{y}+(δ₁+δ₂)CH₄=MₓO_{y-δ1-δ2}+(δ₁+δ₂)(2H₂+CO) (3)

Steam Oxidation: MₓO_{y-δ1-δ2}+δ₂H₂O=MₓO_{y-δ1}+δ₂H₂ (4)

Air Oxidation: MₓO_{y-δ1}+(δ₁/2)O₂=MₓO_{y} (5)

where: CH₄ is used as the fuel, MₓO_{y} is an oxygen carrier, MₓO_{y-δ1} and MₓO_{y-δ1-δ2} are the corresponding reduced oxygen carrier with different reduction degree.

Pure hydrogen can be obtained from the SR outlet by cooling and condensing the steam, without additional gas treatment. This form of chemical looping hydrogen generation process can be described as a combination process of the partial oxidation and steam gasification of solid fuels. The overall process is endothermic.

However, a number of series chemical looping hydrogen generation processes processes of this type tend to produce an undesirable mixed gas product in the fuel reactor through gas bleed between the reactor stages in the series loop and offer a narrower range of process turn down ratio—and thus have less flexibility to changing production or feed condition. Moreover, the efficiency of the hydrogen production is limited by the process flow of both the AR and FR process steps in the loop. Finally, the FR of conventional chemical looping hydrogen generation designs is limited to gas fuels only.

It is therefore desirable to provide an alternative chemical looping process and system for producing hydrogen.

### SUMMARY OF THE INVENTION

The present invention provides a process and system for producing hydrogen based on chemical looping technology, also known as chemical looping hydrogen (CLH2).

A first aspect of the present invention provides a chemical looping process for the production of hydrogen and the co-production of carbon dioxide comprising:

a first redox loop that comprises:

feeding of a first solid oxygen carrier to a first reaction zone (R1) in which a first carbonaceous fuel is also fed, which reacts with the first solid oxygen carrier fed at its maximum oxidising state (fully-oxidised form), leading to the formation of the combustion products carbon dioxide and water and the solid oxygen carrier at a lower oxidising state (reduced form); and

feeding of the first solid oxygen carrier in reduced form to a second reaction zone (R2) into which air is also fed, obtaining, from the oxidation of the first solid oxygen carrier, heat and the solid oxygen carrier in fully-oxidised form to be recycled to the first reaction zone (R1); and

a second redox loop that comprises:

feeding of a second solid oxygen carrier to a third reaction zone (R3) in which a second carbonaceous fuel is also fed, which reacts with the second solid oxygen carrier fed at its an intermediate oxidising state (oxidised form), leading to the formation of the combustion products carbon dioxide and water and the solid oxygen carrier at a lower oxidising state (reduced form); and

feeding of the second solid oxygen carrier in reduced form to a fourth reaction zone (R4) into which water (in the form of steam) is also fed, which reacts with the reduced form of the solid oxygen carrier, producing hydrogen and the solid oxygen carrier at an intermediate oxidising state (oxidised form) to be recycled to the third reaction zone (R3) and/or the first reaction zone (R1),

wherein the first reaction zone (R1) and the third reaction zone (R3) are interconnected allowing transfer of at least a portion of the first solid oxygen carrier from the first reaction zone (R1) to the third reaction zone (R3).

This first aspect of the present invention provides a chemical looping process which includes two parallel redox loops, the first redox loop (also known as an air reactor (AR) loop) and the second redox loop (also known as a steam reactor (SR) loop). Each of these parallel redox loops includes a fuel reactor (combustion reduction) and an oxidation reactor (an air reactor in the first redox loop, and a steam reactor in the second redox loop). The invention relates to an interconnection between the first reaction zone (R1) and third reaction zone (R3) of the respective redox loops (contained in the fuel reactors of the respective redox loops (see below)) that allows at least some of the first solid oxygen carrier from the first redox loop (also known as the air reactor (AR) loop) to flow into the second redox loop (also known as the steam reactor (SR) loop).

This process allows the continuous production of separate streams of H₂ and CO₂ with a high purity, at the same time, with good thermal efficiency created by the selective exchange of heat through solid oxygen carrier transfer from the two separate FR reaction zones (first reaction zone (R1) and third reaction zone (R3)). The CLH2 process of the present invention typically does not require a post purification step and can be flexible with input fuels, providing a simple and versatile hydrogen production process. The process can be applied on laboratory bench and pilot scale through to a large scale i.e. an industrial scale.

The process of the present invention allows an adjustment of heat required for driving the SR loop by regulating transfer of oxygen carrier from R1 to R3. The design and manipulation of internal fuel reactor segregation is preferably configured to allow mass transfer (in the form of solids—a portion of the solid oxygen carrier content) and heat transfer. In embodiments, the interconnection between the first reaction zone (R1) and the third reaction zone (R3) enables at least a portion of the first solid oxygen carrier (mass flow) to be selectively transferred from the first reaction zone (R1) to the third reaction zone (R3). The amount of the first solid oxygen carrier (mass flow) that is selectively transferred from the first reaction zone (R1) to the third reaction zone (R3) can be correlated to provide a required thermal load to the third reaction zone (R3). Preferably, the required thermal load is selected based on a thermal imbalance between the first reaction zone (R1) and third reaction zone (R3). The required thermal load is also selected based on the need to transfer heat and mass from selective regions of the first reaction zone (R1) to selective regions of the third reaction zone (R3) (see below). It should be appreciated that solid circulation rate within the reaction zones can be another important parameter.

The transfer of the first solid oxygen carrier (hot solids) is controlled to control heat transfer from the first reaction zone (R1) to the third reaction zone (R3), so to integrate heat between the two parallel redox loops. The aim is to provide sufficient heat to satisfy heat requirements of the second redox loop (SR loop), specifically the third reaction zone (R3). The heat transfer can be optimised based on factors such as solid oxygen carrier circulation, feed type, feed composition, feed introduction points and thermal balance. In this respect, the first redox loop (the AR loop) produces a larger heat (is a highly exothermic reactor) compared to the second redox loop (the SR loop) as an extent of exothermicity of the first redox loop is larger than that of the second redox loop. In comparison, if the two redox loops were not thermally integrated (i.e. the first and second redox loops are separate redox loops), the second redox loop requires a significant external heat duty, whilst the heat from the first redox loop must be utilised in other ways, for example power generation. Practically, it would be difficult to supply the required heat into the third reaction zone (R3) via traditional methods such as heat transfer surfaces, as the heat exchange area is usually too small for the magnitude of heat transfer required.

The other extreme is that the first redox loop and second redox loop share a single fuel reactor having unsegregated solid oxygen carrier flow throughout. Here, the solid oxygen carrier entering and exiting the first redox loop and the second redox loop are able to intimately mix within a single fuel reactor common to both the first and second redox loops (combining R1 and R3 in a common reaction zone). Whilst such an arrangement would directly thermally integrate the loops, it would not provide any control over the thermal transfer from the first redox loop to second redox loop, leading to energy or heat and control issues over the reactions occurring in each loop. In particular, additional thermal energy (in the form of heat) from the first redox loop useful for other applications (power generation etc.) may be difficult to utilise.

It should be appreciated though that where the intended application is for hydrogen generation, there is less need for power generation. In such applications it is desirable to maximise all the thermal content to maximise hydrogen generation. In this respect, the parallel design of the two redox loops is advantageous in order to prioritise or balance production between heat and hydrogen, which is not possible in a conventional series design (see for example FIG. 1). However, the parallel design of the present invention enables the hydrogen and heat production (as a product) to be decoupled i.e. the amount of hydrogen production from the second redox loop can be increased or decreased, as demand changes, and the amount of process heat produced from the first redox loop can remain constant, decreased or increased in response.

A variety of interconnection configurations can be used to selectively transfer the first solid oxygen carrier from the first reaction zone (R1) to the third reaction zone (R3). In some embodiments, the interconnection between the first reaction zone (R1) and the third reaction zone (R3) comprises at least one controlled solid transfer valve. Any number of controlled solid transfer valves can be used depending on the size of the reactor and the quantum of mass transfer required. In some embodiments, at least two controlled solid transfer valves are used. The solid transfer valves are preferably spaced apart relative to the width of the respective reaction zones (R1, R3).

A variety of solid transfer valves are available that are capable of interconnecting the first reaction zone (R1) and third reaction zone (R3). In preferred embodiments, the solid transfer valve comprises at least one non-mechanical valve, and more preferably at least one loop seal gate. Loop seal gates are a non-mechanical gate which includes at least two fluidised bed sections separated by a weir. One fluidised section is aerated to transfer solids over the weir to the other section. In this way, solids can be transferred through loop seal gate in a single direction (from R1 to R3). Solid transfer can be stopped by the gate through selective control of the amount of aeration of the solids in the sections of the loop seal gate. A loop seal gate therefore provides good control over solid transfer in fluidised bed type arrangements. In the present invention, the loop seal gate therefore provides good control of heat transfer by control of the “hot solid” transfer from R1 to R3, and thus is able to maintain the overall process heat balance.

Nevertheless, it should be appreciated that most typical non-mechanical valves could also be used, including (but not limited to) L-valves, J-valves, V-valves, reverse seal valves, and seal pot valves. Each of these valves uses an aerated gas to allow solid flow through the valve configuration. Flow through the valve can be stopped by stopping the supply of aeration gas.

In other embodiments, the interconnection between the first reaction zone (R1) and the third reaction zone (R3) comprises an aperture or opening. In these embodiments, the aperture or opening is sized to restrict the amount of flow from the first reaction zone (R1) to the third reaction zone (R3). The location of the aperture or opening is also important, to allow flow of the first solid oxygen carrier into both the first redox loop (AR loop) and also selectively transfer first solid oxygen carrier to the third reaction zone (R3) and hence also heat in order to sustain heat required in the second redox loop (SR loop). The aperture or opening is therefore preferably located proximate to or close to an outlet connection through which the reduced first solid oxygen carrier exits from the first reaction zone (R1).

In some embodiments, the first reaction zone (R1) and third reaction zone (R3) are housed in a single reactor (a single overall fuel reactor). That overall fuel reactor can be configured to at least partially segregate/separate the solid oxygen carrier flows of the parallel redox loops. This segregation can be provided using a divider or dividing wall between each reaction zone (R1, R3). Here, the first reaction zone (R1) and the third reaction zone (R3) are substantially separated by the dividing wall, which segregates the flow of each respective solid oxygen carrier in each respective reaction zone (R1, R3). The dividing wall is configured to include the interconnection between the first reaction zone (R1) and the third reaction zone (R3).

In the simplest form (for example, a small scale reactor) the dividing wall may comprise a central divider in a reactor which reduces internal mixing between R1 and R3 and creates a flow path within that reactor. The interconnection can comprise an opening or aperture between the reaction zones (R1 and R3) or a solid transfer valve linking the reaction zones (R1 and R3).

In a larger form, the dividing wall may comprise a central divider within the reactor which is connected by solid transfer valves, for example internal loop seal gates, which allow controlled unidirectional solids flow of the first solid oxygen carrier from the first reaction zone (R1) to the third reaction zone (R3) of the single/shared fuel reactor. In those embodiments, where the interconnection between the first reaction zone and the third reaction zone comprises at least two controlled solid transfer valves, the solid transfer valves are preferably spaced apart along the width of the dividing wall.

The use of a single divided fuel reactor enables the reactor to be configured as a compartment type arrangement aligned for a continuous production of hydrogen. This compact compartment type arrangement enables heat transfer to be controlled via one or more solid transfer valves regulating the exchange of hot solids (solid oxygen carrier) to further and encourage the endothermic reaction of the third reaction zone (R3). This arrangement allows effective management of the heat flow by the oxygen carrier to various parts of the reactor system and can provide for controlling the production of hydrogen in the fourth reaction zone (R4).

The fuel reactor may include one or more separators positioned within the respective reaction zones to aid and optimise the amalgamation/reaction of solid oxygen carrier and fuel. In embodiments, the first reaction zone (R1) can include at least one separator to divide the first reaction zone (R1) into at least two sections between the feed point of the first solid oxygen carrier into the first reaction zone (R1) and outlet to the second reaction zone (R2). Similarly, the third reaction zone (R3) can include at least one separator to divide the third reaction zone (R3) into at least two sections between the feed point of the second solid oxygen carrier into the third reaction zone (R3) and outlet to the fourth reaction zone (R4). In embodiments, the at least one divider comprises one or more baffles. The dividers increase the mean particle path length between the feed point and the outlet point of the respective solid oxygen carriers, thus increasing the residence time of the solid oxygen carriers in each reaction zone (R1, R3) and increasing conversion of the reactants.

The location of the second solid oxygen carrier recycle inlet into the first reaction zone is preferably located to feed that solid oxygen carrier directly or very close to the exit zone of the first reaction zone (R1) leading to the second reaction zone (R2). The second solid oxygen carrier at an intermediate oxidising state (oxidised form) produced from the fourth reaction zone (R4) is preferably recycled to the first reaction zone (R1) close to or proximate the location of the solid oxygen carrier, which is transferred from the first reaction zone (R1) to the second reaction zone (R2). This ensures that the second solid oxygen carrier is fed into a zone in the first reaction zone (R1) where the first solid oxygen carrier is at the same oxidation state (i.e. intermediate oxidising state (oxidised form)).

It should be appreciated that the fully-oxidised form refers to the first solid oxygen carrier in a maximum oxidised state. This typically refers to the first solid oxygen carrier approaching or being in a fully oxidised form. The oxidised form of the first solid oxygen carrier and second solid oxygen carrier refers to these solid oxygen carriers being in a different oxidising state to the fully-oxidised form, at an intermediate oxidising/oxidation state of the relevant solid oxygen carrier. This is typically a partially oxidising state. Similarly, the reduced form of the first solid oxygen carrier or the second oxygen carrier refers to that solid oxygen carrier being in a different oxidising state to the oxidised form and the fully-oxidised form. This may be a reduced or partially reduced form of the respective solid oxygen carrier.

The chemical looping process of the present invention is typically configured to use one or more of fuels (gas, liquid or solid-based) at the same time in the fuel reactors (first reaction zone and/or second reaction zone). The different fuels are intended to be used interchangeably and/or in combination. As noted previously, the carrier activity differs depending on its oxidising state, so different fuels are used for specific oxidising state, allowing more targeted usage of the feed fuel (first and second carbonaceous fuel). The redox potential of the solid oxygen carrier in the first reaction zone typically enables a wide variety of carbonaceous fuels to be used. The first carbonaceous fuel preferably comprises solid, liquid or gaseous carbonaceous fuel. In embodiments, the first carbonaceous fuel is selected from at least one of coals, biomass, oils, or liquid hydrocarbons or gaseous hydrocarbons (for example methane, natural gas, or biogas, industrial waste gases like coke oven gas). It should be appreciated that any gaseous fuels/hydrocarbons may include other reducing gases, for example H₂, CO, syngas or the like. The fuels fed into the third reaction zone are typically a little more restricted. The second carbonaceous fuel preferably comprises a liquid or gaseous carbonaceous fuel. In embodiments, the second carbonaceous fuel comprises a liquid (preferably light liquid) hydrocarbons or gaseous hydrocarbon (for example, those gaseous hydrocarbon with below C6, methane, natural gas, or biogas, industrial waste gases like syngas, pyrolysis gas, cracker gas or coke oven gas). Again, it should be appreciated that any gaseous fuels/hydrocarbons may include other reducing gases, for example H₂, CO, syngas or the like.

The optimum location of the fuel addition for oxygen carrier reduction can then be based on fuel type i.e. gas, liquid or solid, or combination. Moreover, the optimal points for feed introduction can be based on the feed type (gas, liquid or solid) and feed composition (chemical composition)—optimal feed utilisation, inclusion in the bed, residence time. In this set up, the first carbonaceous fuel and second carbonaceous fuel are preferably fed in concurrent flow with the respective state of the solid oxygen carrier.

Other process considerations can be important to the control of the hydrogen production from the second redox loop (the SR loop) and the amount of process heat produced from the first redox loop (the AR loop).

The process is scalable to a pressurised system. Pressurisation will help to increase the throughput of the process for a same reactor footprint. Typical process pressure will be around 20 to 25 bar. In other embodiments, the process pressure will be less than 10 bar. The operating temperature is expected to be greater than 750° C., preferably in the range from 750 to 1000° C., and more preferably in the range from 750 to 950° C.

As discussed above, the first and second solid oxygen carriers act as oxygen donor to the carbonaceous fuel (reducing agent) and oxygen receiver from the oxidising agent (water, typically in the form of steam) in the fourth reaction zone (R4) or oxygen from air in the second reaction zone (R2). The oxygen exchanged through the solid is chemically defined as “reversible oxygen” hereafter indicated as C.O.A. (chemical oxygen available) when it is released and as C.O.D. (chemical oxygen demand) when it is acquired by the solid oxygen carrier. Solid oxygen carriers that can be utilized in the chemical looping process of the present invention preferably satisfy a number of characteristics in order to make the process feasible. These characteristics can include:
(i) High reactivity with carbonaceous fuel, such as hydrocarbon fuels and favourable thermodynamics regarding the fuel conversion to CO₂;
(ii) High redox stability during redox cycles for favourable economics;
(iii) High resistance to agglomeration and sintering;
(iv) High reactivity with O₂ and steam;
(v) High mechanical strength under fluidised conditions;
(vi) Wide redox window;
(vii) High mechanical strength and resistance against attrition;
(viii) High oxygen storage capacity (or reversible oxygen) for a larger H₂ production; and
(ix) High coking resistance.

Whilst the process may operate with different first and second solid oxide carriers, it is preferred that the first solid oxide carrier is the same as the second solid oxide carrier. The first and second solid oxide carriers preferably comprise at least one multivalence metal-based oxide, and more preferably at least one multivalence metal oxide or metal oxide derivative.

The first solid oxygen carrier and the second solid oxygen carrier can comprise any suitable element capable of producing at least two different oxidation states producing at least one redox pair. In some embodiments, the first solid oxygen carrier and the second solid oxygen carrier contains at least one element selected from the group consisting of elements which, in addition to the metallic state, have at least three different oxidation states and are therefore capable of producing at least two redox pairs in the order of the oxidation state.

A number of metal oxides and metal oxide derivatives can be selected that have at least three different oxidation states. In embodiments, the first and second solid oxygen carriers comprise metal oxides selected from at least one Fe-based, Ni-based, W-based, Cu-based, Ce-based or Mn-based oxide. In embodiments, the first and second solid oxygen carriers comprise metal oxides selected from Fe₂O₃, WO₃, SnO₂, Ni-ferrites, (Zn, Mn)-ferrites, and Cu-ferrites. Other examples include perovskites, synthetic oxides and natural occurring minerals such as ilmenite. Iron based oxide solid oxygen carriers are the common active metal oxide. In preferred embodiments, the metallic element contained in the solid oxygen carrier is iron. Iron is preferably present in the solid oxygen carrier in binary form FeₓO_{y} and/or in ternary form FeₓZ_{z}O_{y}, wherein x≥1, y≥0, z≥1 and Z is at least one element selected from the group consisting of Ni, Ti, Mn, Al, Cr, Ga, Ce, Zr, V and Mo. Nevertheless, it should be appreciated that in preferred embodiments iron oxide is the solid oxygen carrier used in the process for hydrogen production. Iron-based oxygen carriers have been found to be the most common, low toxicity and low cost candidates for hydrogen production.

A second aspect of the present invention provides a chemical looping system for the production of hydrogen and the co-production of carbon dioxide comprising:

a first redox loop that comprises:

a first fuel reactor into which is fed a first solid oxygen carrier at its maximum oxidising state (fully-oxidised form) and a first carbonaceous fuel is fed, which reacts to form combustion products, carbon dioxide and water, and the first solid oxygen carrier at a lower oxidising state (reduced form); and

an air reactor into which the first solid oxygen carrier in reduced form and air is fed, to obtain, from the oxidation of the first solid oxygen carrier, heat and the first solid oxygen carrier in fully-oxidised form to be recycled to the first fuel reactor (R1); and

a second redox loop that comprises:

a second fuel reactor into which is fed a second solid oxygen carrier at an intermediate oxidising state (oxidised form) and a second carbonaceous fuel, which reacts leading to the formation of the combustion products carbon dioxide and water and the second solid oxygen carrier at a lower oxidising state (reduced form); and

a steam reactor into which is fed the second solid oxygen carrier in reduced form and steam, which reacts to produce hydrogen and the second solid oxygen carrier at an intermediate oxidising state (oxidised form) to be recycled to the second fuel reactor and/or the first fuel reactor;

wherein the first fuel reactor and the second fuel reactor are interconnected to allow transfer of at least a portion of the first solid oxygen carrier from the first fuel reactor to the second fuel reactor.

This second aspect provides a chemical looping system which includes two parallel operating redox loops. Like the first aspect, the parallel redox loops include two interconnected fuel reactors and two separated oxidation reactors (an air reactor and a steam reactor). The interconnection between the fuel reactors of each redox loop allows at least some metal oxide from the first redox loop (also known as the air reactor (AR) loop) to flow into the second redox loop (also known as the steam reactor (SR) loop). This interconnection is preferably configured to selectively transfer a portion of the first solid oxygen carrier from the first fuel reactor (which contains a first reaction zone (R1)) to the second fuel reactor (which contains a third reaction zone (R3)).

Consistent with the first aspect, the air reactor contains a second reaction zone (R2), and the steam reactor contains a fourth reaction zone (R4). The design and manipulation of the interconnection and segregation between the fuel reactors (and respective reaction zones R1 and R3 of the first and second fuel reactors) of solid oxygen carrier flow enables selective solids and heat transfer—optimised based on feed type, solid oxygen carrier circulation, feed composition and feed introduction points. This enables the system to be thermodynamically balanced as explained above in relation to the first aspect.

A variety of interconnection configurations can be used to selectively transfer the first solid oxygen carrier from the first fuel reactor to the second fuel reactor. In some embodiments, the interconnection between the first fuel reactor and the second fuel reactor comprises at least one controlled solid transfer valve. Where there are at least two controlled solid transfer valves, the solid transfer valves can be spaced apart relative to the width of the respective reaction zones within each fuel reactor. The one solid transfer valve or values may comprise at least one non-mechanical valve, preferably at least one loop seal gate. It should be appreciated that other non-mechanical valves could also be used, including (but not limited to) L-valves, J-valves, v-valves, reverse seal valves, and seal pot valves. Each of these valves uses an aeration gas to allow solid flow through the valve configuration. Flow through the valve can be stopped by stopping the supply of aeration gas.

In other embodiments, the interconnection between the first fuel reactor and the second fuel reactor comprises an aperture or opening.

The first fuel reactor and the second fuel reactor can be configured as two separate reactors linked through a physical interconnection, for example a solid flow conduit or similar. However, reactor costs (CAPEX) can be reduced by forming the two fuel reactors (and the comprising reaction zones R1 and R3) within a single common reactor vessel. In these embodiments, the first fuel reactor and the second fuel reactor may comprise a single reactor substantially separated by a dividing wall, which segregates the flow of each respective solid oxygen carrier within each fuel reactor, the dividing wall including the interconnection between the first fuel reactor and the second fuel reactor. As above, that interconnection may be at least one solid transfer valve, or at least one opening or aperture. Where the interconnection between first fuel reactor and the second fuel reactor comprises at least two controlled solid transfer valves, the solid transfer valves being spaced apart along the width of the dividing wall.

As indicated above, each fuel reactor may include one or more separators positioned within the respective reaction zones (R1 and R3) within the reactor to aid and optimise the amalgamation/reaction of solid oxygen carrier and fuel. In embodiments, the first fuel reactor can include a reaction zone which includes at least one separator to divide the reaction zone into at least two sections between the feed point of the first solid oxygen carrier into the reaction zone and outlet to the air reactor. Similarly, in embodiments, the second fuel reactor includes a reaction zone can include at least one divider to divide the reaction zone into at least two sections between the feed point of the second solid oxygen carrier into the reaction zone and outlet to the steam reactor. The at least one divider preferably comprises one or more baffles.

The configuration of the separator or baffle is preferably designed to maximise mixing of metal oxide with fuel at appropriate oxidation state and contact time/residence time. In some embodiments, the baffle comprises at least one dividing member which extends from the outer perimeter of the reaction zone, inwardly towards the opposite side of the reaction zone, to at least 1/3, preferably at least 1/2 the width of the reaction zone. The baffle can include a second dividing member which extends at an angle from the first dividing member substantially along the particle flow direction of the solid oxygen carrier within the reaction zone. The baffle comprises a substantially L-shaped barrier extending into the reaction zone from an outer perimeter of the reaction zone. However, it should be appreciated that other separator configurations could be used.

The reactor is preferably configured to use different fuels (solid, liquid, gas) and these are fed at different feed locations corresponding to the reduction potential of the metal oxide in that part of the reactor. Different fuel types (solid, liquid or gas) require different introduction/feed methods into a fluidised bed and interact differently when introduced into the bed. Reactors are therefore designed with a particular fuel type in mind. Feeding more than one fuel type and being able to specify the feed location based on the combination of feed types (and feed composition), is important to efficient interaction of the solid metal oxide and fuel to ensure reaction efficiency, as well as for the heat management of the fuel reactor and overall CLH2 system. The fuel feed points and preferred different fuel type preferably take into consideration the oxidation state of oxygen carrier and reaction kinetics of different fuels to determine the strategic location of fuel injection. The transition metal oxide has different reducibility at different state. Using different fuel types enables the reduction degree to be optimised and hence maximise hydrogen production. For example, Fe₂O₃→Fe3O₄ is easier than Fe₃O₄→FeO. For the easier reduction step, solid fuel could be used but for a harder reduction step like Fe₃O₄→FeO, use gas fuel which is stronger reducing agent than the solid fuel form.

In embodiments, the first carbonaceous fuel is fed into the first fuel reactor at a location close to or proximate the location of the solid oxygen carrier is fed into the first fuel reactor from the air reactor. In embodiments, the second fuel reactor includes a liquid feed inlet for liquid fuels at a location close to or proximate the location of the second solid oxygen carrier is fed into the second fuel reactor from the steam reactor. It should be noted that while the current fuel feeding arrangement is done the following way (solid, liquid and gaseous), in theory the gaseous fuel can be introduced in all zones from solid to just before steam reactor.

In embodiments, the second solid oxygen carrier used for the steam reactor at an intermediate oxidising state (oxidised form) is preferably recycled to the first fuel reactor at a location close to or proximate the location of the solid oxygen carrier is transferred from the first fuel reactor to the air reactor.

Again, the first solid oxygen carrier and the second solid oxygen carrier can comprise any suitable element capable of producing at least two different oxidation states producing at least one redox pair. Preferably, the first and second solid oxide carriers preferably comprise at least one multivalence metal based oxide, and more preferably at least one multivalence metal oxide or metal oxide derivative. As taught in relation to the first embodiment, the first solid oxygen carrier and the second solid oxygen carrier preferably contain at least one element selected from the group consisting of elements which, in addition to the metallic state, have at least three different oxidation states and are therefore capable of producing at least two redox pairs in the order of the oxidation state. A number of metal oxides and metal oxide derivatives can be selected that have at least three different oxidation states. In embodiments, the first and second solid oxygen carriers comprise metal oxides selected from at least one Fe-based, Ni-based, W-based, Cu-based, Ce-based, Mn-based oxide. In some embodiments, the first and second solid oxygen carriers comprise metal oxides selected from Fe₂O₃, WO₃, SnO₂, Ni-ferrites, (Zn, Mn)-ferrites, Cu-ferrites, and Ce based oxides. Other examples include perovskites, synthetic oxides and natural occurring minerals such as ilmenite. Iron based oxide solid oxygen carriers are the common active metal oxide. In preferred embodiments, element contained in the solid oxygen carrier is therefore iron. The iron is preferably present in the solid oxygen carrier in binary form FeₓO_{y} and/or in ternary form FeₓZ_{z}O_{y}, wherein x≥1, y≥0, z≥1 and Z is at least one element selected from the group consisting of Ni, Ti, Mn, Al, Cr, Ga, Ce, Zr, V and Mo. Nevertheless, it should be appreciated that iron oxide is determined to be a desired solid oxygen carrier for hydrogen production. Iron-based oxygen carriers have been found to be the most common, low cost and low toxicity candidates for hydrogen production. The reactivity and the stability during the redox have been investigated in different reactor type. Whilst the system may operate with different first and second solid oxide carriers, it is preferred that the first solid oxide carrier is the same as the second solid oxide carrier.

The system of the present invention can include a number of further process steps or vessels. In embodiments, the system further includes at least one cyclone between the air reactor and first fuel reactor to separate gas from the first solid oxygen carrier in fully-oxidised form prior to being fed into the first fuel reactor. Similarly, at least one cyclone can be included between the steam reactor and first fuel reactor to separate gas from the second solid oxygen carrier in oxidised form prior to being fed into the second fuel reactor or first fuel reactor.

The various reactors are preferably separated and/or isolated using one or more additional non-mechanical valves position in the fluid connections that link the reactors. In some embodiments, the system further comprises at least one non-mechanical valve, preferably at least one loop seal gate, on each of the inlet and outlet connections between each of the first fuel reactor and air reactor and each of the inlet and outlet connections between each of the second fuel reactor and the steam reactor. The non-mechanical gates are designed to ensuring the solid oxygen carrier moves through the between reactors (e.g. from the first fuel reactor to air reactor) in one direction with sufficient design to minimise or eliminate solids movement in the opposite direction, and also control the rate of transfer at these intersections. The non-mechanical gates can also be designed to ensure minimal gas contamination from one segment of the fuel to the other or from one reactor to another, for example from the first fuel reactor to air reactor.

The fuel reactors, air reactor and steam reactor can comprise any suitable process vessel configured for solid-gas, solid-liquid, solid-solid mixing and reaction. In embodiments, the first fuel reactor and second fuel reactor comprise fluidised bed reactors. In embodiments, the air reactor comprises a fluidised bed reactor or a riser. In the riser, air and the oxidised solid oxygen carrier are fed therein in concurrent flow. In embodiments, the steam reactor comprises a fluidised bed reactor.

It should be appreciated that the present invention can also improve process safety through the isolation of explosive gas mixture using external loop seals.

The chemical looping system of the present invention finds particular application in at least one of the following areas:
Hydrogen production
Power generation
Carbon dioxide production
Nitrogen production
Ammonia production (combination of N₂ and H₂ in the presence of catalyst)

### BRIEF DESCRIPTION OF THE DRAWINGS

The present invention will now be described with reference to the Figures of the accompanying drawings, which illustrate particular preferred embodiments of the present invention, wherein:

FIG. 1 provides a process flow diagram of a prior art CL system for H₂ production arranged with the reactors operating in a series configuration.

FIG. 2 provides a process flow diagram of a first embodiment of a CLH2 system according to the present invention arranged with the reactors operating in a parallel configuration.

FIG. 3 provides a process schematic of a second embodiment of a CLH2 system according to the present invention in parallel operation for small scale application and moderate operating pressure, for example up to 5 bars.

FIG. 4 provides a third embodiment of a CLH2 system according to the present invention in parallel operation configured for large scale processing and a high operating pressure, for example up to 20 bars, wherein (a) is a plan view process schematic; and (b) is a side view process schematic.

FIG. 5 illustrates (a) schematic of the chemical looping fuel reactor according to an embodiment of the present invention with the loop seal gate (LS) separating the two reactor chambers; (b) the dimensions of the fuel reactor shown in (a) considered in the two-dimensional CFD modelling.

FIG. 6 illustrates the results of a simulated oxygen carrier transfer phenomenon in the modelled fuel reactor design shown in FIG. 5.

FIG. 7 illustrates a plot showing one second moving average of solid mass flux into and out of the loop seal gate of the modelled fuel reactor design as shown in FIG. 5.

FIG. 8 illustrates the set up and geometry of a three-dimensional reactor model according to an embodiment of the present invention showing: a) plan view and b) 3-D iso-view (quarter segment).

FIG. 9 illustrates the transfer and mixing phenomena of the oxygen carrier via the proposed multiple loop seal approach from the model shown in FIG. 8.

FIG. 10 shows a CLH2 reactor arrangement according to an embodiment of the present invention showing flow of oxygen carrier, feed and product streams.

FIG. 11 is a plot showing the temperature profiles of the proposed CLH2 shown in FIG. 10 for four selected scenarios.

FIG. 12 is a plot showing the change of iron species/phase in the fuel reactor of the CLH2 reactor shown in FIG. 10 simulated for scenario 1.

### DETAILED DESCRIPTION

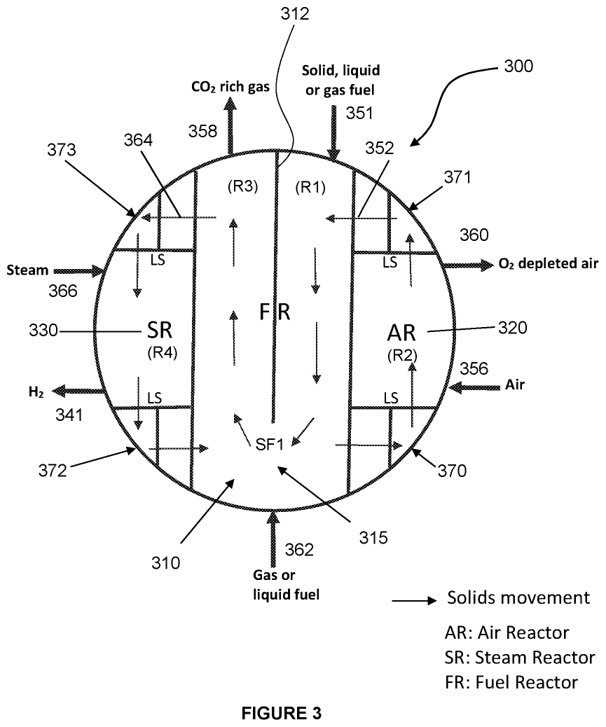

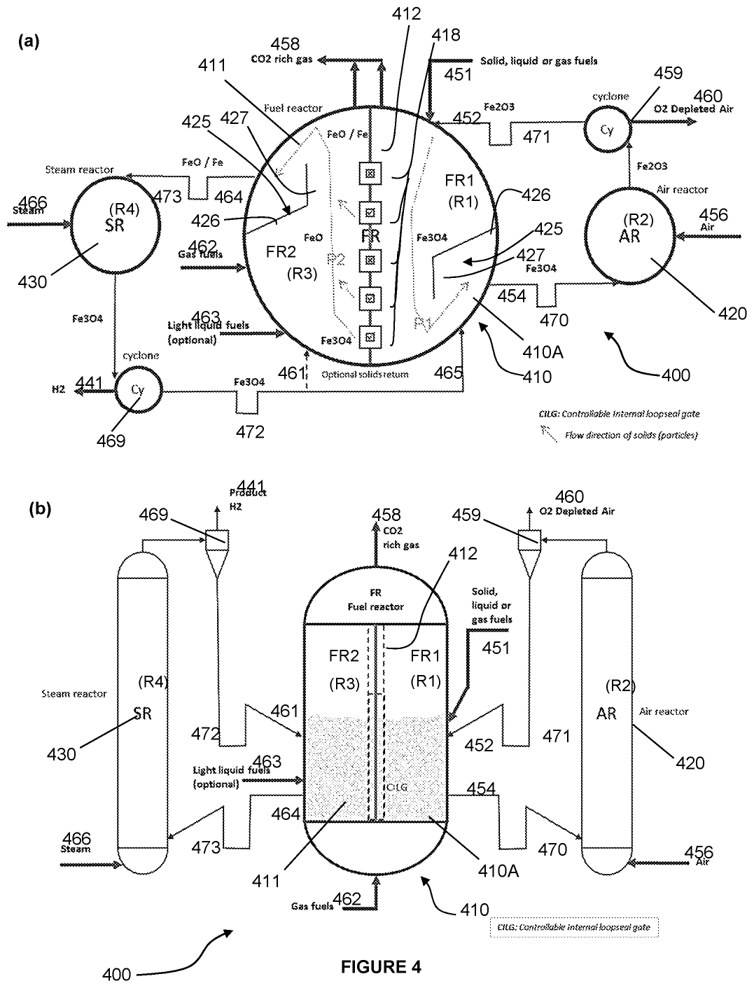

The present invention provides a chemical looping (CL) process and system which includes a reactor design specifically aimed for the production of hydrogen from multiple types of fuels (interchangeable or in combination), while producing a concentrated CO₂ stream. The process and system of the present invention has application from bench-scale (for example FIG. 3) to commercial/industrial scale operation (for example FIG. 4).

### Chemical Looping Systems

CLH2 systems for producing hydrogen include three basic reactors used to produce hydrogen and carbon dioxide/process heat, namely:
A fuel reactor (FR) operated under reducing conditions, in which solid oxygen carrier particles (typically metal oxides as discussed above) are reduced by fuels fed into the FR. The fuels are oxidised to CO₂ and H₂O;
An air reactor (AR) operated under oxidising conditions, in which the solid oxygen carrier particles are oxidised with gaseous oxygen from air. This reaction is exothermic so produces heat. The excess AR heat duty can be used to produce steam for electricity generation via a steam turbine and/or via expansion of the AR off-gas.
A steam reactor (SR) also operated under partial oxidising conditions, in which the solid oxygen carrier particles are oxidised with steam (i.e. water in the form of steam) producing hydrogen.

These three reactors can be configured in series or parallel configuration.

### Series Chemical Looping Process

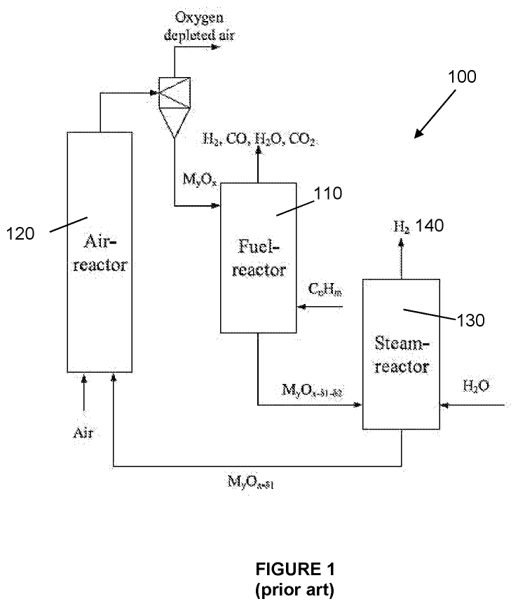

An example of a series configuration is illustrated in FIG. 1 (prior art configuration). This series system 100 arranges each of the FR 110, AR 120 and SR 130 in a single redox loop. As explained in the background, the FR 110 is used to partially reduce the solid oxygen carrier and the reduced solid oxygen carrier is oxidised by steam in the SR 130 to recover lattice oxygen and simultaneously produce hydrogen 140. The AR 120 is then used to recover the lattice oxygen completely. The overall process is exothermic.

### Parallel CLH2 Process

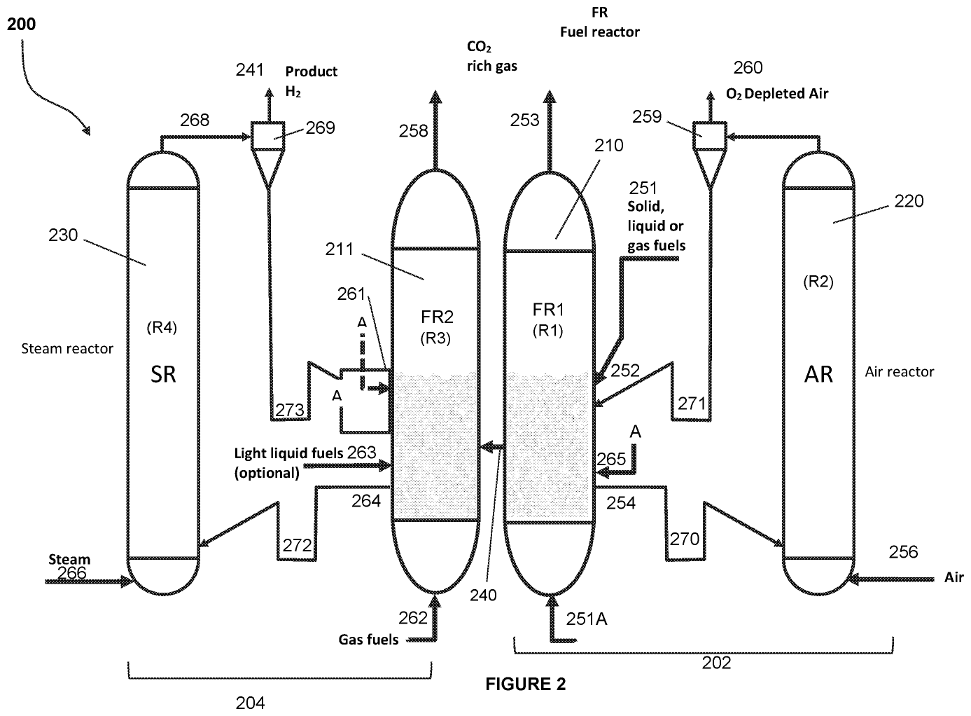

The CLH2 system of the present invention is a parallel process. As shown in FIG. 2, the parallel process 200 includes two parallel redox loops 202 and 204 comprising a first redox loop 202 including a first FR 210 connected with an AR 220 and a second redox loop 204 comprising a second FR 211 connected with a SR 230. These redox loops 202 and 204 are operated in parallel, with the FR 210, 211 of each redox loop 202, 204 interacting through a solids transfer connection 240. FIGS. 3 to 5 show other examples of CLH2 processes and systems based on the parallel operation according to the present invention.

FIG. 2 shows the basic process flow diagram for the parallel CLH2 process and system 200 according to a first embodiment of the present invention.

Firstly, referring to the AR loop (first redox loop) 202. In this loop, FR1 210 includes a first reaction zone (R1) in which a carbonaceous fuel 251 (solid, liquid or gas) and a first solid oxygen carrier is fed in at its maximum oxidising state (fully-oxidised form i.e. approaching or at fully oxidised form). Gaseous fuels are also typically fed into an inlet 251A located the bottom of the FR1 210 to provide fluidising gas for the solid contents in therein. In addition to gaseous fuel, the fluidisation can be supported by recycled CO₂ in the FR1 210 and CO₂ from FR2 211. Combustion products carbon dioxide and water are formed and exit at the top of the reactor at outlet 253. The first solid oxygen carrier is reduced to a lower oxidising state (reduced form) and exits the FR1 210 at solid outlet 254. The first solid oxygen carrier in the reduced form is fed using solid transport means (conveyer, riser, fluidised system or the like) to the AR 220 into a second reaction zone (R2) into which air is also fed from inlet 256. In the second reaction zone R2, the first solid oxygen carrier is oxidised to a fully-oxidised form which is recycled to the first reaction zone (R1) via inlet 252. AR 220 also produces heat and an oxygen depleted gas stream 260 (impoverished air) which is separated from the first solid oxygen carrier using a cyclone or other separator 259. Where methane is used as the fuel source, the redox reactions can be as follows (further explained below in solid oxygen carrier section):

Fuel Reactor Reduction: MₓO_{y}+(δ₁+δ₂)CH₄=MₓO_{y-δ1-δ2}+(δ₁+δ₂)(2H₂+CO) (6)

Air Reactor Oxidation: MₓO_{y-δ1-δ2}+(δ₁+δ₂/2)O₂=MₓO_{y} (7)

In the SR loop (second redox loop) 204, a second solid oxygen carrier at an intermediate oxidising state (oxidised form) is fed via inlet 261 into a third reaction zone (R3) in which a second carbonaceous fuel is also fed via inlet 262 (gas fuels) and/or inlet 263 (light liquid fuels). In R3, the second carbonaceous fuel reacts with the second solid oxygen carrier leading to the formation of the combustion products carbon dioxide and water which exit at the top of the reactor at outlet 258. The second solid oxygen carrier is reduced to a lower oxidising state (reduced form) which is fed using solid transport means (conveyor, riser, fluidised system or the like) to the SR 230 into a fourth reaction zone (R4). Water, typically in the form of steam, is also fed into R4 from inlet 266. The steam reacts with the reduced form of the solid oxygen carrier, producing hydrogen which exits at top outlet 241 and the solid oxygen carrier at an intermediate oxidising state (oxidised form) which is recycled (as shown by [A] connections to FR1 and FR2) to FR2 (third reaction zone (R3)) via inlet 261 or FR1 (first reaction zone (R1)) via inlet 265. Cyclone 269 is used to separate the solid oxygen carrier and hydrogen product, (assuming that all the steam is consumed by the reaction. Hence, no steam is condensed in the cyclone or elsewhere). Where gaseous fuel such as methane is used as the fuel source, the redox reactions can be as follows (further explained below in solid oxygen carrier section):

Fuel Reactor Reduction: MₓO_{y-δ1}+δ₂CH₄=MₓO_{y-δ1-δ2}+δ₂(2H₂+CO) (8)

Steam Reactor Oxidation: MₓO_{y-δ1-δ2}+δ₂H₂O=MₓO_{y-δ1}+δ₂H₂ (9)

The fuel reactors FR1 210 and FR2 211 include an interconnection between which allows at least some solid oxygen carrier from the FR1 210 to flow into FR2 211. That interconnection can take various forms as explained in more detail below.

As shown in FIG. 2, the gaseous environment in the respective reaction zones R1, R2, R3 and R4 of FR1 210, FR2 211, AR 220 and SR 230 are isolated using a solid transfer valves preferably loop seal arrangements 240, 270, 271, 272 and 273.

### Solid Oxygen Carrier

The first solid oxygen carrier and the second solid oxygen carrier can comprise any suitable element capable of producing at least two different oxidation states producing at least one redox pair. Preferably, the first and second solid oxide carriers preferably comprise at least one multivalence metal-based oxide, and more preferably at least one multivalence metal oxide or metal oxide derivative. In preferred embodiments, solids which can be used as the first and second solid oxygen carriers are those containing at least one element selected from elements having at least three different oxidation states, stable under the reaction conditions, which differ in their oxygen content and in that they are capable of cyclically passing from the most reduced form to the most oxidised form and vice versa. It is noted that whilst not essential, the first and second solid oxygen carrier are preferably the same metal oxide or metal oxide derivative.

Solids containing one or more elements with the above characteristics can be used, i.e. having, in addition to the metallic state, at least three different oxidation states, preferably three states, and capable of producing in the order of oxidation state, at least two redox pairs, preferably two pairs, and can be adopted as such or in a mixture with other elements which are not subject to redox reactions; the reactive phase thus obtained can, in turn, be used as such or suitably dispersed or supported on compounds such as silica, alumina, or other pure oxides such as oxides of magnesium, calcium, cerium, zirconium, titanium, or lanthanum, but also mixtures thereof.

Among solids having at least three different oxidation states, iron proves to be particularly advantageous, and can be present in the solid in binary form FeₓO_{y} and/or in ternary form FeₓZ_{z}O_{y}, wherein x≥1, y≥0, z≥1, Z is at least an element selected from Ni, Ti, Mn, Al, Cr, Ga, Ce, Zr, V and Mo. In a preferred form, the solid oxygen carrier comprises iron oxide. In this embodiment, in each reactor, the oxygen carriers react with fuels, air or steam as for example expressed in the following equilibrium reactions:

Fuel reactor FR1 210, FR2 211:

CₓH_{y}+3Fe₂O₃=xCO₂+yH₂O+2Fe₃O₄ (10)

CₓH_{y}+Fe₃O₄=xCO₂+yH₂O+3FeO (11)

CₓH_{y}+FeO=xCO₂+yH₂O+Fe (12)

Air reactor AR 220:

1/2O₂+N₂+2Fe₃O₄=N₂+3Fe₂O₃ (13)

Steam reactor SR 230:

H₂O+Fe=H₂+FeO (14)

H₂O+3FeO=H₂+Fe₃O₄ (15)

In the third reaction zone (R3), the element selected from elements having at least three different oxidation states (i.e. the element of the second solid oxygen carrier) can optionally consist of two phases deriving from the fact that the oxidation step in R4 is not able to completely recover lattice oxygen of many ternary forms due to thermodynamic limitation, resulting in the incomplete conversion of the element. When the element is iron, the two phases are FeO and Fe₃O₄. Thus, reactions (11) and (12) typically occur in the third reaction zone (R3) of FR2 211 (FIG. 2).

Reaction 10 occurs in the first reaction zone (R1) of FR1 210. This coupled with the overall AR loop 202 being exothermic enables this loop to provided thermal support to the SR loop 204 (which is endothermic) through the transfer of energy (thermal energy) between the FR reaction zones (R1 to R3) using the solid oxygen carriers.

From a reactor point of view, thermal support between the AR and SR loops 202 and 204 can be affected through the selective mass transfer of the solid oxygen carriers from the respective FR reaction zones R1 and R3 of FR1 210 and FR2 211 respectively, for example using loop seal gates (see below in relation to the system described for FIG. 4). The amount of solid oxygen carrier transferred can be determined by the overall heat balance of the AR reactor 220 and SR reactor 230 and reactive systems at the various reaction temperatures and the thermal balance on each reactor 210, 211, 220 and 230.

The transfer of solids (hot metal oxide) is controlled to control heat transfer from the first reaction zone (R1 on the AR loop) to the third reaction zone (R3 on the SR loop), so to provide heat integration between the two parallel redox loops 202 and 204. The aim is to provide sufficient energy to satisfy heat requirements of the endothermic nature of the SR loop 204 (SR is slightly exothermic, FR2 is endothermic—overall endothermic), specifically in R3 (211)—see reactions (11) and (12). In this respect, the AR loop 202 produces far more heat (is a highly exothermic reactor) compared to the SR loop 204.

The parallel design of the present invention enables the hydrogen and heat production (as a product) to be decoupled i.e. the amount of hydrogen production from the SR loop 204 can be increased or decreased, as demand changes, and the amount of process heat produced from the AR loop 202 can remain constant, decreased or increased in response.

The fuel reactors 210 and 211 containing the first and third reaction zones (R1, R3) can be carried out in a fluidised bed reactor according to the art. In other embodiments, the fuel reactors 210 and 211 containing the first and third reaction zones (R1 and R3, respectively) can be carried out in a moving bed reactor according to the art.

The air reactor 220 containing the second reaction zone (R2) can be carried out by feeding gas and solid in co-current to a riser with the subsequent re-entry of this solid to the first phase of the process, preferably by pneumatic conveyance. In other embodiments, a fluidised bed or transport reactor can be used according to the art.

The steam reactor 230 housing the fourth reaction zone (R4), can be carried out in fluidised bed reactor according to the art. In other embodiments, the steam reactor 230 can comprise a multi-step reactor, and at a temperature selected on the basis of the thermodynamics and kinetics of the reaction to which steam (oxidising agent) is fed in continuous in upflow and the solid oxygen carrier MeₓZ_{z}O_{y} (reducing agent) in downflow, in a molar ratio of reduced oxide to steam which can be lower than or equal to, preferably lower than 1 (excess oxidising agent), at the stoichiometry of the reaction, and a stream of H₂ and steam is removed in continuous from above, whereas a stream of MeₓZ_{z}O_{(y+1)} is removed from below, which can be recycled to the third reaction zone (R3) or the first reaction zone (R1).

Where a fluidised bed reactor is used according to the art, that fluidised bed reactor can be equipped with dividers whose function is to guide the movement of the solid and thus improve the oxygen exchange between solid and gas. Various types of dividers can be used (for example, perforated plates; chevron) depending on the rheological characteristics of the gas and solid.

### Fuel Reactor Design

The fuel reactors FR1 and FR2 illustrated in FIG. 2 can have a number of configurations. As indicated in FIG. 2, those reactors 210 and 211 can be constructed separately. However, as shown in FIGS. 3 and 4, each of fuel reactors FR1 and FR2 and respective reaction zones R1 and R3 can also be housed in a single overall fuel reactor 310, 410. That overall fuel reactor 310, 410 can be configured to at least partially segregate/separate the metal oxide flows of the parallel redox loops.

FIG. 3 shows the inventive system 300 in its simplest form (for example a small scale reactor), with all four reaction zones R1, R2, R3 and R4 housed in a compact reactor. It should be appreciated that this system has similar components to the system 200 shown in FIG. 2, and therefore reference numerals for like components are the same as system 200 plus 100. In this embodiment, the central fuel reactor 310 comprises a divided chamber having a central dividing wall 312 separating reaction zones R1 and R3. The dividing wall 312 is positioned between the recycle inlet 352 for the solid oxygen carrier entering the first reaction zone R1 and the solid oxygen carrier outlet 364 of the third reaction zone R3. The dividing wall 312 is positioned to maximise the solids flow SF1 through both reaction zones. The dividing wall reduces back flow and by-passing and creates a flow path for the solid oxygen carrier within the fuel reactor 310 in the direction of the arrows shown in the FR 310. The fuel reactor 310 and dividing wall 312 therefore provide an internal design facilitating directed internal circulation of reactants along a flow path SF1 through reactions zone R1 to R2 therein. In this embodiment, the interconnection between the reaction zones R1 and R3 comprise an opening or aperture 315. The gaseous environment in the reaction zones R1 and R3 are isolated from reaction zones R2 and R4 using a solid transfer valves, preferably loop seal (LS) arrangements 370, 371, 372 and 373. The overall arrangement enables the FR 310, AR 320 and SR 330 to be housed in a single compact reactor housing.

FIG. 4 provides a configuration of the system 400 for a large scale process. It should be appreciated that this system has similar components to the system 200 shown in FIG. 2, and therefore reference numerals for like components are the same as system 200 plus 200. In this embodiment, a central dividing wall 412 is located within the single fuel reactor 410 which includes a number of solid transfer valves 418 spaced apart along the width of the dividing wall 412. The dividing wall 412 divides the single fuel reactor (FR) 410 into two segregated fuel reactors, namely fuel reactor FR1 410A which includes the first reaction zone (R1) and fuel reactor FR2 411 which includes the third reaction zone (R3). In the illustrated embodiment, the solid transfer valves 418 comprise internal loop seal gates which allow controlled unidirectional solids flow of the first solid oxygen carrier from the first reaction zone (R1) to the third reaction zone (R3) of the single fuel reactor 410. As explained above, the transfer of solids (hot solid oxygen carrier) through the solid transfer valves 418 is controlled to control heat transfer from the first reaction zone (R1) to the third reaction zone (R3), so to provide heat integration between the two parallel redox loops. The aim is to provide sufficient energy to satisfy heat requirements of the endothermic reaction of the SR loop, especially R3.

The illustrated fuel reactor 410 includes two generally L-shaped separators or baffles 425 within each reaction zone R1, R3. The baffles 425 comprises a first dividing member 426 which extends from the outer perimeter of the reaction zone R1 or R3, inwardly towards the opposite side of the reaction zone R1 or R3, to at least 1/3, preferably at least 1/2 the width of the reaction zone R1 or R3. The baffles 425 can includes a second dividing member 427 which extends at an angle from the first dividing member 426 substantially along the particle flow direction of the solid oxygen carrier within the reaction zone. It should be appreciated that other separator configurations could be used.

The baffles 425 divide the reaction zone into at least two sections between the feed point of the solid oxygen carrier into the reaction zone R1, R3 and exit to the respective AR 420 or SR 430 to direct flow of reactants within the reaction zones R1 and R3 as illustrated by the dotted flow path P1 and P2. The baffles 425 aid and optimise the amalgamation/reaction of solid oxygen carrier and fuel by increasing the mean particle path length between the feed point (451, 452, 465 for R1 and 461, 462, 463 for R3) and the outlet of the respective solid oxygen carriers (454 for R1 and 464 for R3), thus increasing the residence time of the solid oxygen carriers in each reaction zone R1, R3 and increasing conversion of the reactants.

### Carbonaceous Fuel

The fuel reactors 210, 211, 310, 410 of the chemical looping hydrogen process of the present invention are configured to in combination or interchangeably use one or more types of fuels (gas, liquid or solid-based). As shown in FIG. 2, the first carbonaceous fuel preferably comprises solid, liquid or gaseous carbonaceous fuel for example coals, biomass, oils, or liquid or gaseous hydrocarbons (any gaseous or vaporised fuels for example methane or natural gas, LPG or (waste) fuel gases). The fuels fed into the third reaction zone R3 are typically a little more restricted. The second carbonaceous fuel preferably comprises a liquid or gaseous carbonaceous fuel such as a liquid hydrocarbon or a gaseous hydrocarbon (again any gaseous or vaporised fuels for example methane or natural gas, LPG or (waste) fuel gases). It should be appreciated that any gaseous fuels/hydrocarbons may include other reducing gases, for example H₂, CO, syngas or the like.

Different fuel types (solid, liquid or gas) require different introduction/feed methods into a fluidised bed and interact differently when introduced into the bed.

As shown in FIG. 4, the first carbonaceous fuel (a solid, liquid or gas) is fed into the first reaction zone R1 of the first fuel reactor FR1 at a location 451 close to or proximate the location 452 of the solid oxygen carrier is fed into the first reaction zone R1 from the air reactor (AR) 420. Similarly, the second fuel reactor FR2 includes a liquid feed inlet 463 for liquid fuels at a location close to or proximate the location 461 of the second solid oxygen carrier is fed into the second fuel reactor FR2 from the steam reactor (SR) 430. The second fuel reactor FR2 also includes a gas fed inlet 462 for gaseous fuels located at the base of the fuel reactor (FIG. 4(b)).

Finally, from FIG. 4 it can be seen that the location of the second solid oxygen carrier recycle inlet 465 into the first reaction zone (R1) is located to feed that solid oxygen carrier directly or very close to the outlet 454 of the solid oxygen carrier which is transferred from the first reaction zone (R1) to the second reaction zone (R2). This ensures that the fed second solid oxygen carrier is fed into a zone in the first reaction zone (R1) where the first solid oxygen carrier is at the same oxidation state (i.e. intermediate oxidising state (oxidised form)).

### Advantages

Whilst not wishing to limit the scope of the present invention, the inventors consider that the present invention combines this with know-how of hydrodynamics (interaction between gas and solid particles) to produce a reactor design capable of solids transfer among the three internal fluidisation chambers, as well as within the fuel reactor. This enables the following improvements:
Utilisation of optimal points for the introduction of different fuel feeds into the FR based on the feed type (gas, liquid or solid) and feed composition (chemical composition).
Separation of reaction zone (for sufficient conversion) from disengagement zone (to direct oxygen carrier to the air reactor or the fuel reactor).
Design and manipulation of internal fuel reactor segregation to allow selective solids and heat transfer—optimised based on solid oxygen carrier circulation rate, feed type, feed composition and feed introduction points.
Ensuring metal oxides moves through the internal fuel reactor gates or from one reactor to the other (e.g. fuel reactor to air reactor) in one direction with sufficient design to minimise or eliminate solids movement in the opposite direction, and also control the rate of transfer at these intersections.
Ensuring minimal gas contamination from one segment of the fuel to the other, or from one reactor to another e.g. from fuel reactor to air reactor, and between air reactor and steam reactor.
Prioritisation/balancing of heat and hydrogen production—for a given parallel design, the hydrogen and heat production (as a product) can be decoupled i.e. the amount of hydrogen production can be increased or decreased, as demand changes, and the amount of process heat produced can remain constant, decreased or increased in response.
Greater overall process flexibility depending on the different fuel mixture.

Incorporating the hydrodynamics into the design ensures the particular design is not only based on a feasible choice of metal oxide, thermodynamics and reaction kinetics, but also ensures the engineering practicality and operability of the unit for example ensuring sufficient design aspects to ensure solids mixing and transfer in the fuel reactor, solid transfer rate through the fuel reactor gates, solid transfer rate in the loop seals, practical reactor dimensions.

### EXAMPLES

The following examples have been prepared using computational fluid dynamic (CFD) simulations and engineering calculations to exemplify some of the key features of the present invention, with particular focus on validating:
1. The functionality of a loop seal gate for transferring oxygen carrier from one chamber to the other in a chemical looping fuel reactor and to quantify the solids fluxes from such mechanism.
2. The functionality of multiple loop seal gates for distributing the oxygen carrier into another reactor chamber from solids mixing consideration.
3. The functionality of solids distribution via loop seal gates for managing the temperature profile within the fuel reactor—in order to maintain and optimise chemical looping reaction.
4. The functionality of multi fuel injection to regulate the temperature profile in a fuel reactor.

### Example 1: Computational Fluid Dynamic (CFD) Models

Two types of models were developed for this example. A first model was based on a two-dimensional model which shows how the loop seal gate operation can assist the transfer of oxygen carrier from one side of the fuel reactor to another. A second model was based on a three-dimensional model which demonstrates both solids transfer and mixing phenomena of oxygen carrier through the proposed loop seal gate arrangements.

### 1.1 MODEL 1—Two-Dimensional Solids Transfer and Flux

### 1.1.1 Purpose

The purpose of this model was to:
show a feature of a loop seal gate for transferring solid oxygen carrier from one side of the fuel reactor to another.
quantify the mass flux of the solid oxygen carrier from the one side of the fuel reactor to another via the loop seal gate.

### 1.1.2 Approach and Model Description

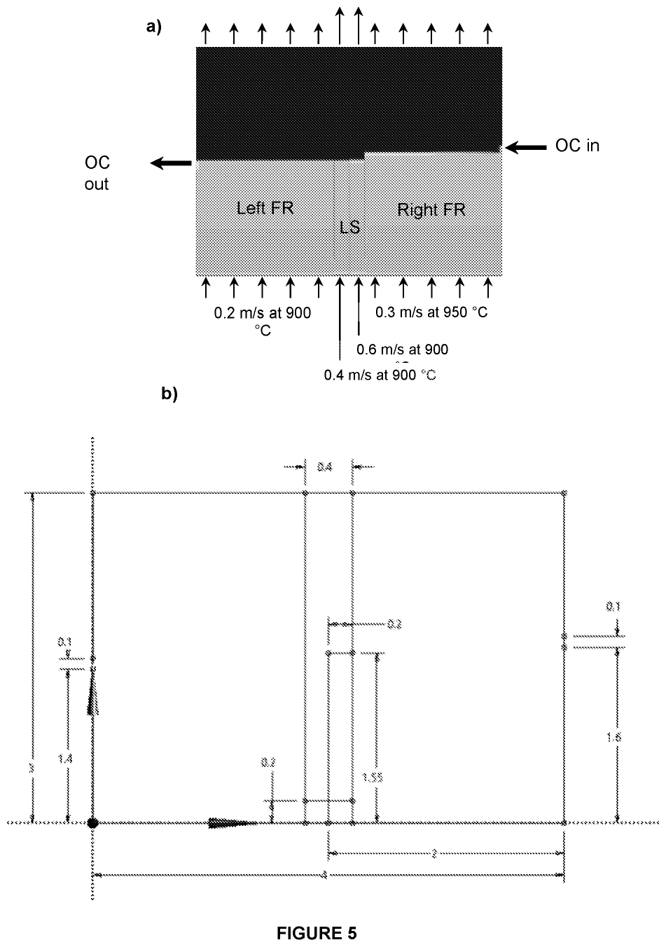

A two-dimensional CFD model was developed to demonstrate the functionality of the proposed loop seal gate (LS) for transferring the solid oxygen carrier (OC) from one side of the fuel reactor to another side in the proposed fuel reactor design of the chemical looping process, as well as estimating its mass flux. FIG. 5 shows (a) schematic and (b) geometry used in the two-dimensional model. In the model, the diameter and density of the oxygen carrier were set at 150 μm and 4400 kg/m³, respectively, and the oxygen carrier enters from one chamber of the fuel reactor (e.g. right hand side of the reactor (FR-R) shown in FIG. 5a) and it was discharged to other fuel reactor chamber (e.g. left hand side of the reactor (FR-L) shown in FIG. 5a) through the underflow slots. The initial oxygen carrier bed heights of the right and left chamber of the fuel reactor were set at 1.6 m and 1.4 m, respectively (FIG. 5b). The overall diameter of the fuel reactor was 4 m with the loop seal gate (0.4 m×0.4 m) arranged in the middle of the fuel reactor. The loop seal gate had 0.2 m×0.2 m underflow slots for the oxygen carrier to transfer from one chamber (right) to the other chamber (left) of the fuel reactor. The fluidising gas for the right fuel reactor chamber entered from the bottom with a gas velocity of 0.3 m/s at 950° C. while for the left fuel reactor it was set at 0.2 m/s at 900° C. The loop seal gate was fluidised with the gas velocity of 0.6 m/s and 0.4 m/s in the first and second compartment, respectively. The simulation was conducted with a reactor operating pressure of 20 bar,a.

### 1.1.3 Results

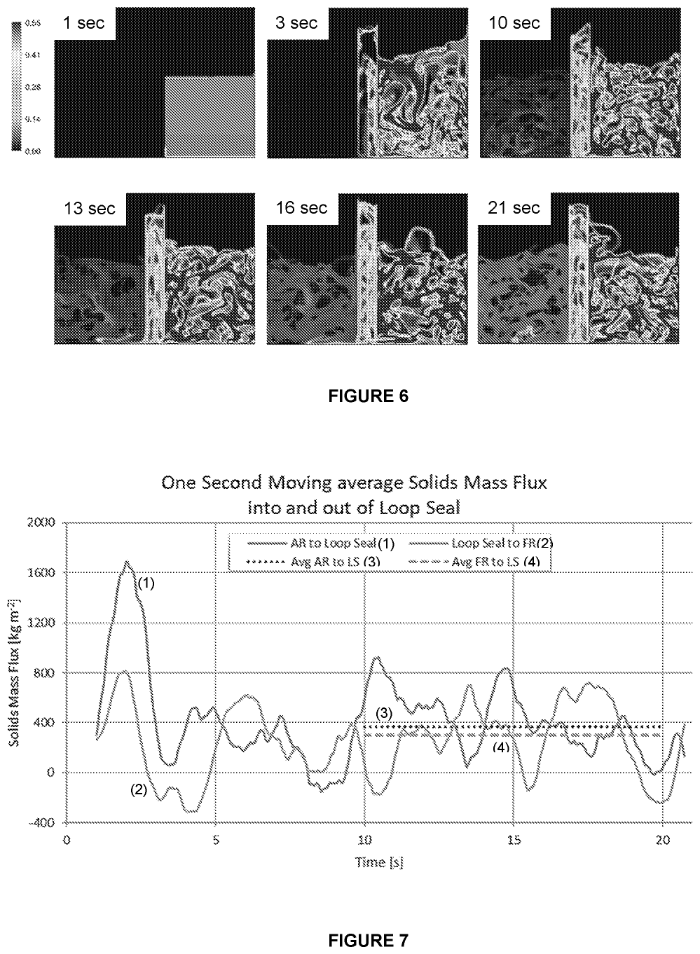

FIG. 6 shows time-series flow patterns of oxygen carrier transferring (or migrating) from one chamber of the fuel reactor to the other via a loop seal gate arrangement. The colour gradient shows the concentration of solids species initially present in the left reactor chamber. The simulation was conducted up to 21 seconds which was shown to reach a pseudo-steady state fluidisation condition. In 3 seconds, the oxygen carrier can be seen entering the inlet of the loop seal gate and being transferred over into its outlet.

By 21 seconds, a substantial quantity of the oxygen carriers can be seen being transferred across to the other side of reactor chamber as aided by the flow within the loop seal gate.

The model also allows quantification of the solid mass fluxes moving across the loop seal gate (FIG. 7). Following an initial surge (due to dynamic modelling condition), the average solid mass fluxes reach a pseudo-state condition. The fluxes entering and exiting the loop seal gate were estimated to be approximately 370 and 300 kg/m²·s respectively (see dashed lines in FIG. 7). The calculation shows that the oxygen carrier rate was sufficiently high to support the chemical looping process.

### 1.2 MODEL 2—Three-Dimensional CFD Model

### 1.2.1 Purpose

The purpose of this model was to:
demonstrate the functionality and effectiveness of multiple loop seal gate in distributing the solids as oxygen and heat carrier from one reaction chamber to the other.

### 1.2.2 Model Description and Assumptions

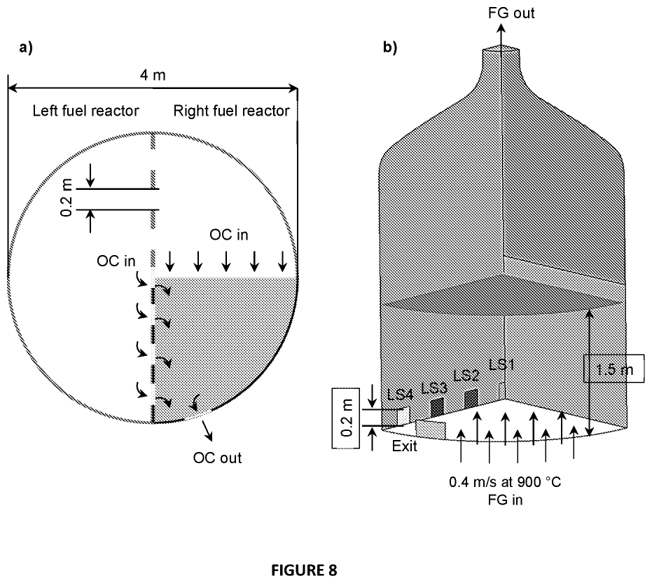

A three-dimensional CFD model was developed to demonstrate the transfer and mixing patterns of the oxygen carrier via the proposed multiple loop seal gate approach within the fuel reactor. Simulations were carried out for a quarter segment of the reactor as shown in FIG. 8 which includes a) the plan view of the reactor and b) 3-D iso-view of the model. Similar to the two-dimensional model, the particle size and density of the oxygen carrier were set at 150 μm and 4400 kg/m³, respectively. The oxygen carrier enters the target reaction zone via two mechanisms, one via the loop seal gates and another from the other reaction zone within the reactor as shown in FIG. 8a.

The initial oxygen carrier bed height was set at 1.5 m, as shown in FIG. 8b. The diameter of the overall fuel reactor was 4 m while each loop seal gate has a dimension of 0.2 m height×0.2 m width, except for LS1 which has 0.2 m height×0.1 m width (due to model boundary condition).

The overall solid flow rate flowing into the targeted reaction zone was set at 320.5 kg/s. The flow rate through each loop seal gate was set at 15 kg/s except for the loop seal gate 1 (LS1) which was set at 7.5 kg/s due to the half of the gate area compared to the other loop seal gates (LS2, LS3 and LS4) from model boundary condition consideration. This flow rate was determined based on the average mass flux estimated from the two-dimensional CFD model. The remaining solid flow of 268 kg/s was supplied from another quarter of the fuel reactor zone. The fluidising gas (molecular weight of 29 g/mol) entered from the bottom of the target reaction zone at a gas velocity of 0.4 m/s. The fluid and bed particle temperatures and system pressure were maintained at 900° C. and 20 bar,a respectively.

### 1.2.3 Results

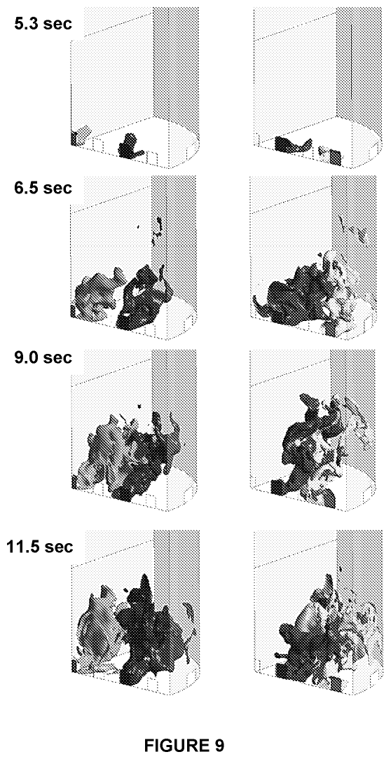

FIG. 9 shows the time-series flow patterns of oxygen carrier entering and mixing in the target reaction zone via the multiple loop seal gates. The oxygen carrier was tagged with different shades to allow easy visualisation and tracing of the particle movement. The mixing patterns of the solids were predicted at 5.3, 6.5, 9.0 and 11.5 seconds after the first release of solids tracer through the loop seal gates. The oxygen carriers were shown to progressively dispersed and mixed in the target reaction zone within a short time, demonstrating the effectiveness of this approach for transferring the oxygen (and heat) carrier throughout the intended bed area.

This observation provides the confidence that the present invention can effectively deliver heat and regulate the bed temperature in the target reaction zone using the oxygen carrier as heat transfer medium.

### Example 2—Engineering Calculation (Heat Transfer and OC Speciation)

The following examples illustrate the effectiveness of this mechanism for controlling the bed temperature in other zone of the reactor through solid transfer and mixing.

### 2.1 Purpose

The purpose of the engineering calculation was to:
demonstrate the ability to control the temperature profiles in a targeted reaction zone by regulating the solids flow through the multiple loop seal gates as well as changing the choice and injection location of the fuel.
To predict the profiles of the oxygen carrier speciation in the fuel reactor.

### 2.2 Model Description and Assumptions

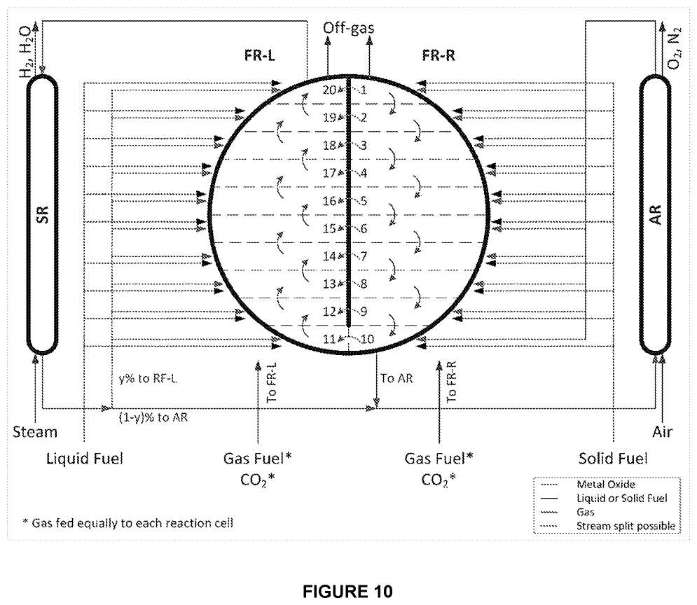

An engineering heat and mass balance model was developed to allow prediction of the temperature profiles across the different regions (zones) of the fuel reactor while demonstrating the effectiveness of loop seal gates in regulating the profiles. The overall reactor configuration for the production of hydrogen using the chemical looping approach was shown in FIG. 10. In this configuration, the fuel reactor was divided into two main chambers [left (FR-L) and right (FR-R)] separated by a series of loop seal gates.

For the engineering model, each fuel reactor chamber was further divided into smaller reaction zones (10 in this case). The fuel reactor may be fed with different fuels (gas, liquid or solids). FIG. 10 also shows the flow direction of the bulk of oxygen carrier from one zone to the other. For each zone, there are provisions for by-passing the oxygen carrier to the adjacent reaction zone via one of the many loop seals. Mass and energy balance including reaction and convective flow of the fluid and solids are conducted to determine the resultant temperature of the bed in each reaction zone. Different scenarios are proposed in order to evaluate the overall temperature profiles across the different reaction zones which could be facilitated by different loop seal operations or the choice of fuels and location of fuel injection.

The following assumptions were used for the engineering calculations:
Two tonnes per day production of H₂ (83.33 kg/h) as a basis;
Fe₂O₃ was used as oxygen carrier and was defined as fully oxidised state;
The oxygen carrier (MeOₓ) from the steam reactor (SR) and air reactor (AR) can be recycled to either zone (cells) within the reaction chambers (FR-L and FR-R), respectively;
The fraction of MeOₓ directed to FR-L was adjusted based on the amount of MeOₓ directed from a FR-R zone to the adjacent FR-L zone;
Irrespective of the total amount of MeOₓ fed to a FR chamber, or its feed distribution, the oxygen was converted equally in each zone (i.e. assumed 10% oxygen conversion per pass);
The reduction of oxygen carrier was assumed to progress from Fe₂O₃ to Fe₃O₄, FeO and finally Fe. The reverse was true for the oxidation reactions. In addition to the iron oxide, the bed material was also assumed to include inert material acting as heat carrier. Up to 70% of inert content has been considered.
Liquid fuel (C₆H₆) and solid fuel (coal) can be introduced to any of the zones (or cells) within the FR-L and FR-R, respectively;
Gaseous fuel (a mixture of CH₄, C₂H₆ and C₃H₈ if chosen) was fed uniformly to each cell within the reaction chamber;
CO₂ was chosen as a fluidisation gas if the fuel reactor was fed with solid fuel and it was fed uniformly to each cell within the reaction chamber;
The steam or fuel (gas, liquid or solid) feeds to the reactor are assumed at stoichiometric ratios (i.e. no excess);
However, a 10% excess air was allowed for the feed to air reactor;
The air and steam reactors are operated at 1050° C. and 800° C., respectively;
Each zone in FR-L and FR-R are assumed to be at adiabatic condition (zero heat differential), resulting in a temperature distribution along the two chambers;
Each reaction was occurring at or just above atmospheric pressure (40 kPa,g);
Fixed extent of reaction conversion was used in each reaction chamber;
Feed streams are assumed at the following temperatures, i.e. after the pre-heating condition:
   Steam at 800° C. and 1 bar;
   Gaseous fuel to the fuel reactor at 750° C. (Or solid fuel and CO₂ to FR-R);
   Liquid fuel to FR-L at 250° C.;
   Air to the air reactor at 1050° C.

### 2.3 Results

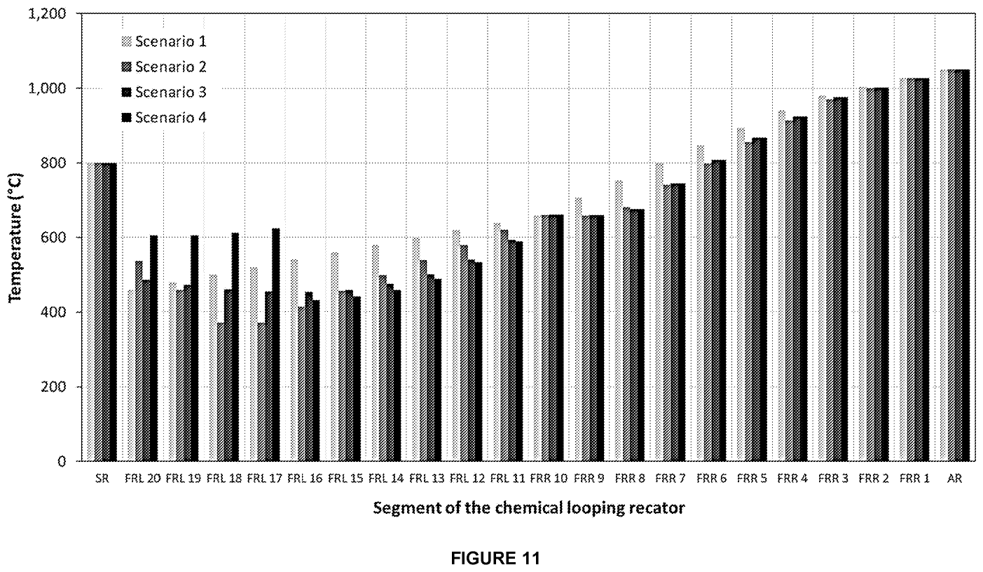

FIG. 11 shows the temperature profiles calculated from the engineering model for four different reactor operating scenarios namely:

Scenario 1: A Base Case setting where the gaseous fuel was used and injected into all the zones within the fuel reactor without opening of any loop seal gates.

Scenario 2: A second case (Case 2) where the gaseous fuel was used and injected into all the zones within the fuel reactor, and the loop seal gates in reaction zone 1 and 2 are opened, allowing 10% of the oxygen carrier in the reaction zone 1 and 2 to be transferred to reaction zones 20 and 19, respectively.

Scenario 3: A third case (Case 3) where the gaseous fuel was used and injected into all the zones within the fuel reactor, and all the loop seal gates are opened, allowing 5% of the oxygen carrier in the reaction zone (1-10) to be transferred to reaction zones (11-20).

Scenario 4: A fourth case (Case 4) where the injection of two fuels (gaseous and liquid fuels) was used where the liquid fuel was injected into the reaction zone 17 while other arrangements are the same as the Case 3.

The simulation results show that the loop seal gate action for solids transfer has a notable impact on the bed temperature profiles, confirming the its controllability and effectiveness (see FIG. 11). Given the rapid mixing behaviour as illustrated in the previous section using the 3-D CFD model, an excellent heat transfer and mixing could be expected, resulting in relatively uniform temperature within each reaction zone.

The result also shows a notable impact on the temperature profile when different fuel was injected into a given zone. In Scenario 4, the liquid fuel was injected into the reaction zone 17. This resulted in a large increase in the temperature in the reaction zones 17 to 20 due to higher heat of reaction, which demonstrates the flexibility and benefit of the proposed reactor design in managing heat flow and temperature profiles within the fuel reactor.

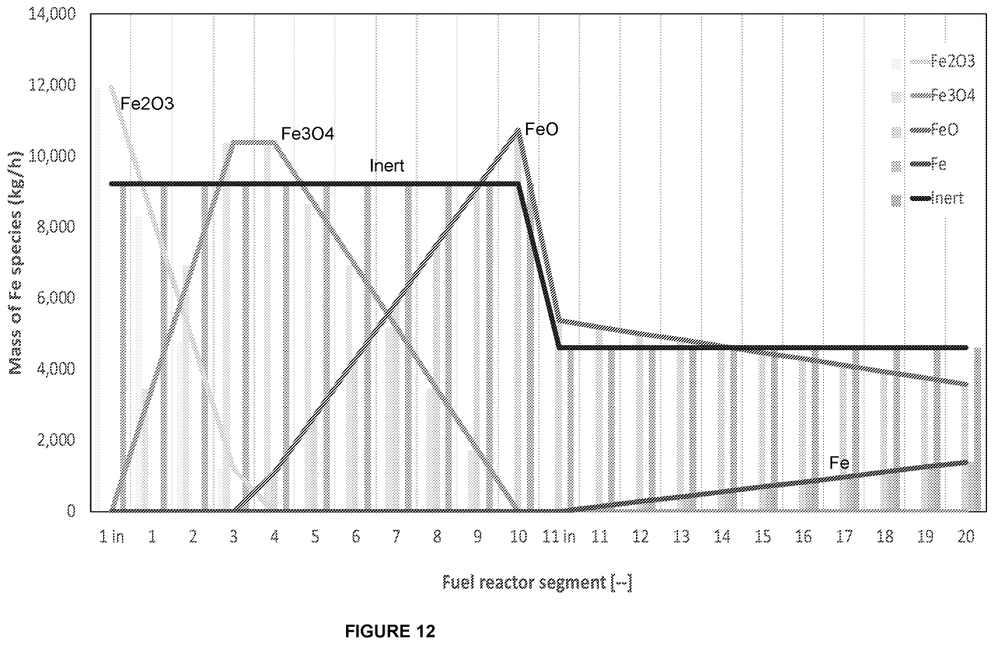

The current reactor configuration also permits good control of the oxidation state of the metal oxides in different zones of the reactor. FIG. 12 shows the change of oxygen carrier oxidation state across the different reaction zones for the Base Case scenario. The concentration profiles of different iron oxide species (i.e. from Fe₂O₃ to Fe₃O₄, FeO and Fe) are shown to be progressively changing from reaction zones 1 to 20. The profiles are influenced by a number of factors such as fuel type and rate, extent of reduction, solids flux and quantity in recycle streams.

Based on the current reactor configuration, it was theoretically possible to optimise the metal speciation to maximise the production rate of the H₂ in the steam reactor.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

1. A chemical looping process for the production of hydrogen and the co-production of carbon dioxide comprising:
a first redox loop that comprises:
feeding of a first solid oxygen carrier to a first reaction zone (R1) in which a first carbonaceous fuel is also fed, which reacts with the first solid oxygen carrier fed at its maximum oxidising state (fully-oxidised form), leading to the formation of the combustion products carbon dioxide and water and the solid oxygen carrier at a lower oxidising state (reduced form); and
feeding of the first solid oxygen carrier in reduced form to a second reaction zone (R2) into which air is also fed, obtaining, from the oxidation of the first solid oxygen carrier, heat and the solid oxygen carrier in fully-oxidised form to be recycled to the first reaction zone (R1); and
a second redox loop that comprises:
feeding of a second solid oxygen carrier to a third reaction zone (R3) in which a second carbonaceous fuel is also fed, which reacts with the second solid oxygen carrier fed at its an intermediate oxidising state (oxidised form), leading to the formation of the combustion products carbon dioxide and water and the solid oxygen carrier at a lower oxidising state (reduced form); and
feeding of the second solid oxygen carrier in reduced form to a fourth reaction zone (R4) into which steam is also fed, which reacts with the reduced form of the solid oxygen carrier, producing hydrogen and the solid oxygen carrier at an intermediate oxidising state (oxidised form) to be recycled to the third reaction zone (R3) and/or the first reaction zone (R1),
wherein the first reaction zone (R1) and the third reaction zone (R3) are interconnected allowing transfer of at least a portion of the first solid oxygen carrier from the first reaction zone (R1) to the third reaction zone (R3).

2. A process according to claim 1, wherein the interconnection between the first reaction zone (R1) and the third reaction zone (R3) enables at least a portion of the first solid oxygen carrier to be selectively transferred from the first reaction zone (R1) to the third reaction zone (R3).

3. A process according to claim 2, wherein at least a portion of the first solid oxygen carrier is selectively transferred from the first reaction zone (R1) to the third reaction zone (R3) to provide a required thermal load to the third reaction zone (R3) and wherein the required thermal load is selected based on a thermal imbalance between the first reaction zone (R1) and third reaction zone (R3).

4. (canceled)

5. A process according to claim 1, wherein the interconnection between the first reaction zone (R1) and the third reaction zone (R3) comprises at least one controlled solid transfer valve.

6. A process according to claim 1, wherein the interconnection between the first reaction zone (R1) and the third reaction zone (R3) comprises at least two controlled solid transfer valves, the solid transfer valves being spaced apart relative to the width of the respective reaction zones.

7. A process according to claim 1, wherein the interconnection between the first reaction zone (R1) and the third reaction zone (R3) comprises at least one non-mechanical valve, preferably at least one loop seal gate; or an aperture or opening.

8. (canceled)

9. A process according to claim 1, wherein the first reaction zone (R1) and third reaction zone (R3) are housed in a single reactor and wherein the first reaction zone (R1) and the third reaction zone (R3) are substantially separated by a dividing wall, which segregates the flow of each respective solid oxygen carrier in each respective zone, the dividing wall including the interconnection between the first reaction zone (R1) and the third reaction zone (R3) preferably comprises at least two controlled solid transfer valves, the solid transfer valves being spaced apart along the width of the dividing wall.

10. (canceled)

11. (canceled)

12. A process according to claim 1, wherein the first reaction zone (R1) includes at least one separator to divide the first reaction zone (R1) into at least two sections between the feed point of the first solid oxygen carrier into the first reaction zone (R1) and exit to the second reaction zone (R2).

13. A process according to claim 1, wherein the third reaction zone (R3) includes at least one separator to divide the third reaction zone (R3) into at least two sections between the feed point of the second solid oxygen carrier into the third reaction zone (R3) and outlet to the fourth reaction zone (R4).

14. (canceled)

15. A process according to claim 1, wherein the solid oxygen carrier at an intermediate oxidising state (oxidised form) from the fourth reaction zone (R4) is recycled to the first reaction zone (R1) close to or proximate the location of the solid oxygen carrier is transferred from the first reaction zone (R1) to the second reaction zone (R2).

16. A process according to claim 1, wherein the first carbonaceous fuel comprises solid, liquid or gaseous carbonaceous fuel, and wherein the second carbonaceous fuel comprises a liquid or gaseous carbonaceous fuel, preferably a liquid hydrocarbon or gaseous hydrocarbon.

17. (canceled)

18. (canceled)

19. (canceled)

20. A process according to claim 1, wherein the first carbonaceous fuel and second carbonaceous fuel are fed in concurrent flow with the respective solid oxygen carrier.

21. A process according to claim 1, wherein the first solid oxygen carrier and the second solid oxygen carrier contains at least one element selected from the group consisting of elements which, in addition to the metallic state, have at least three different oxidation states and are therefore capable of producing at least two redox pairs in the order of the oxidation state, preferably metal oxides selected from Fe₂O₃, WO₃, SnO₂, Ni-ferrites, (Zn, Mn)-ferrites, and Cu-ferrites.

22. (canceled)

23. (canceled)

24. A process according to claim 1, wherein the element contained in the solid oxygen carrier is iron, wherein the iron is present in the solid oxygen carrier in binary form FeₓO_{y} and/or in ternary form FeₓZ_{z}O_{y}, wherein x≥1, y≥0, z≥1 and Z is at least one element selected from the group consisting of Ni, Ti, Mn, Al, Cr, Ga, Ce, Zr, V and Mo.

25. (canceled)

26. A chemical looping system for the production of hydrogen and the co-production of carbon dioxide comprising:
a first redox loop that comprises:
a first fuel reactor into which is fed a first solid oxygen carrier at its maximum oxidising state (fully-oxidised form) and a first carbonaceous fuel is a fed, which react to form combustion products carbon dioxide and water and the solid oxygen carrier at a lower oxidising state (reduced form); and
an air reactor into which the first solid oxygen carrier in reduced form and air is fed, to obtain, from the oxidation of the first solid oxygen carrier, heat and the first solid oxygen carrier in fully-oxidised form to be recycled to the first fuel reactor; and
a second redox loop that comprises:
a second fuel reactor into which is fed a second solid oxygen carrier at an intermediate oxidising state (oxidised form) and a second carbonaceous fuel, which react leading to the formation of the combustion products carbon dioxide and water and the second solid oxygen carrier at a lower oxidising state (reduced form); and
a steam reactor into which is fed the second solid oxygen carrier in reduced form and steam, which react to produce hydrogen and the second solid oxygen carrier at an intermediate oxidising state (oxidised form) to be recycled to the second fuel reactor and/or the first fuel reactor;
wherein the first fuel reactor and the second fuel reactor are interconnected to allow transfer of at least a portion of the first solid oxygen carrier from the first fuel reactor to the second fuel reactor.

27. A system according to claim 26, wherein the interconnection between the first fuel reactor and the second fuel reactor is configured to selectively transfer a portion of the first solid oxygen carrier from the first fuel reactor to the second fuel reactor.

28. A system according to claim 26, wherein the interconnection between the first fuel reactor and the second fuel reactor comprises;
at least one controlled solid transfer valve, preferably at least one non-mechanical valve, more preferably at least one loop seal gate; or
an aperture or opening.

29. (canceled)

30. (canceled)

31. A system according to claim 26, wherein the first fuel reactor and the second fuel reactor comprises a single reactor substantially separated by a dividing wall, which segregates the flow of each respective solid oxygen carrier within each fuel reactor, the dividing wall including the interconnection between the first fuel reactor and the second fuel reactor.

32. (canceled)

33. A system according to claim 26, wherein the first fuel reactor includes a reaction zone which includes at least one separator to divide said reaction zone into at least two sections between the feed point of the first solid oxygen carrier into the reaction zone and outlet to the air reactor wherein the second fuel reactor includes a reaction zone which includes at least one divider to divide said reaction zone into at least two sections between the feed point of the second solid oxygen carrier into the reaction zone and outlet to the steam reactor.

34. (canceled)

35. (canceled)

36. A system according to claim 26, wherein the solid oxygen carrier produced from the steam reactor at an intermediate oxidising state (oxidised form) is recycled to the first fuel reactor at a location close to or proximate the location of the solid oxygen carrier is transferred from the first fuel reactor to the air reactor.

37.-45. (canceled)
